(19) United States
(12) Patent Application Publication
(10) Pub. No.: US 2024/0069059 A1
(43) Pub. Date: Feb. 29, 2024

(54) DEVICE FOR MEASURING WIND ON A POWER KITE

(71) Applicant: Benjamin Charles Lovelady, WHITE SALMON, WA (US)

(72) Inventor: Benjamin Charles Lovelady, WHITE SALMON, WA (US)

(21) Appl. No.: 18/456,367

(22) Filed: Aug. 25, 2023

Related U.S. Application Data
(60) Provisional application No. 63/401,118, filed on Aug. 25, 2022.

(51) Int. Cl. G01P 5/24; F03D 5/00; G01P 5/06; G01P 5/10; G01P 13/02

(52) U.S. Cl. CPC G01P 5/245; F03D 5/015; G01P 5/06; G01P 5/10; G01P 13/02; F05B 2260/83

(57) ABSTRACT

Described is a device for measuring wind conditions during power kite activities. The device comprises an electronic processing unit, an anemometer, and a means of attachment to a power kite. The data from the anemometer is processed by the processing unit and stored locally or transmitted wirelessly to a secondary device (e.g. a smart phone or smart watch). The anemometer directly measures the apparent wind at the kite. In certain embodiments inclusion of an inertial measurement unit and a GPS unit provides a means of calculating the true wind by accounting for induced wind from kite and kiter motion respectively.

### CROSS-REFERENCE TO RELATED APPLICATIONS

This application claims the benefit of U.S. Provisional Application No. 63/401,118, filed 25 Aug. 2022, which application is incorporated herein by reference.

### TERMINOLOGY

This document uses the term “power kite” to mean any steerable kite with adjustable angle of attack. This includes 4-line leading edge inflatable kites commonly used for kiteboarding, but also ram-air kites used in hydrofoil racing and snow-kiting, as well as any steerable kite flown for the power it generates.

This document uses the term “kiter” as a catch-all term for a power-kite flier. This includes kiteboarders, snow kiters, race-foilers, land-boarders, etc. but is not intended to exclude commercial power kite flying. If the control of the kite is automated, the “kiter” should be interpreted as the controller of such a system.

This document uses the term “means of attachment” as an inclusive term covering both mounting and incorporation. Thus, a kite with the device built in and a device meant to be mounted onto a kite are both covered.

### BACKGROUND OF THE INVENTION

Wind speed and quality are the primary environmental factors for kiters to learn new tricks, jump higher, and have fun. Many kiting locations have wind sensors, but their readings tend to be of dubious quality as these sensors are often in wind shadows or simply too low to the ground to properly represent the wind the kite experiences. This leads to uncertainty when deciding when, where, and how to ride. Real-time wind conditions where kites are flying is much more useful data than static wind sensors in non-ideal locations.

The power kites used in kiteboarding typically comprise a wing with an inflatable leading edge and one or more inflatable struts that provide the canopy with structure, as seen in U.S. Pat. No. 7,810,759B2.

While the inclusion of electronic hardware onto a power kite is not novel, using that hardware for the purpose of wind tracking is novel. U.S. Pat. No. 9,957,043 B2 describes mounting a pressure meter to the leading edge of a kite, with one embodiment being an electronic pressure sensor, but with the intention of displaying the pressure on the device itself. US 2017/0174361A1 describes utilizing an IMU and processor to determine kite position for the purposes of directing a light mounted on the kite in front of the kiter's path.

### SUMMARY OF THE INVENTION

Described is a device used to measure the wind velocity at a power kite comprising at least one anemometry sensor and at least one processing unit (e.g. a microcontroller).

The various means of attachment to a power kite are plentiful. The device may be placed anywhere on the leading edge, trailing edge, canopy, or onto a strut. However, the device should be placed where the air flow disturbance and impact to kite handling are minimal.

For leading edge inflatable kites, the ideal location is the center of the leading edge of the kite, mounted such that the airflow path is unimpeded at any angle of attack of the kite. In certain embodiments, the means of attachment involves integrating the device into the leading edge, including but not limited to embedding the electronics inside the leading edge, with the leading edge itself forming part of the air flow path. In certain other embodiments, the means of attachment is to hold the device onto the leading edge of the kite using a mount.

The anemometer may take the form of a vane anemometer as described in U.S. Pat. No. 34,321A, a hot-wire anemometer as described in U.S. Pat. No. 3,464,269A, or any alternative form of anemometer, but an ultrasonic anemometer as described in U.S. Pat. No. 3,693,433A is uniquely suited to this task due to the sand exposure, water exposure, and impact forces recreational power kites undergo.

Because the kite naturally orients itself into the wind, the anemometer needs only to measure wind in 1 dimension. Thus one embodiment utilizing an ultrasonic anemometer contains only one pair of ultrasonic transducers.

In certain embodiments, further inclusion of an inertial measurement unit allows for determining the amount of measured (apparent) wind that is due to the induced wind from the kite motion.

In the simplest of such embodiments, the inertial measurement unit is used to detect when the kite is in a stable configuration where such induced wind is small, and in more complex embodiments the affect on apparent wind across the device is characterized according to kite motion and calibrated out.

One embodiment would also comprise a magnetometer allowing for the kite orientation to be determined relative to cardinal directions and thereby estimate the direction of the true wind.

Another embodiment would also comprise a barometer to estimate the altitude of the kite to further refine the estimate of the motion of the kite.

In some embodiments, the data from sensors on the device is stored locally, and analyzed after the kite is landed.

In certain embodiments, the device further comprises a wireless antenna, allowing the collected data to be shared in real time. Data from other environmental sensors included on the device can also be shared. For example: temperature, humidity, or pressure.

In certain embodiments a GPS unit is included, either on the device itself or via wireless coupling to another processing unit (e.g. a smart phone or smart watch on the kiter). By measuring the horizontal velocity, the amount of measured apparent wind due to induced wind from kiter motion can be determined.

In embodiments with both an inertial measurement unit and a GPS unit, the true wind can be calculated by subtracting the induced wind from kite motion and kiter motion. If the device is wirelessly connected to an internet-capable device (e.g. a smart phone or smart watch) the wind data can be uploaded in real-time for other wind sports users to see.

### BRIEF DESCRIPTION OF DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1. A power kite with inflatable leading edge.

FIG. 2. A leading edge inflatable power kite with an embodiment of the device attached via integration into the leading edge.

FIG. 3. A leading edge inflatable power kite with an embodiment of the device attached via a mount magnets embedded into the leading edge.

FIG. 4. A leading edge inflatable power kite with an embodiment of the device attached via a mount strapped to the center strut.

FIG. 5. A leading edge inflatable power kite with an embodiment of the device attached via an anchor on the leading edge.

FIG. 6. An embodiment of the device attached to the canopy of a ram-air power kite.

FIG. 7. An embodiment of the device utilizing a 1-dimensional ultrasonic anemometer.

FIG. 8. An embodiment of the device utilizing a vane anemometer.

FIG. 9. An embodiment of the device utilizing a hot-wire anemometer.

### DETAILED DESCRIPTION OF THE INVENTION

A device for measuring wind speed conditions at a power kite is described. The device comprises at least one anemometry sensor, at least one electronic processing unit connected to said anemometry sensor and configured to process the data from said sensor, and a means of attachment to a power kite.

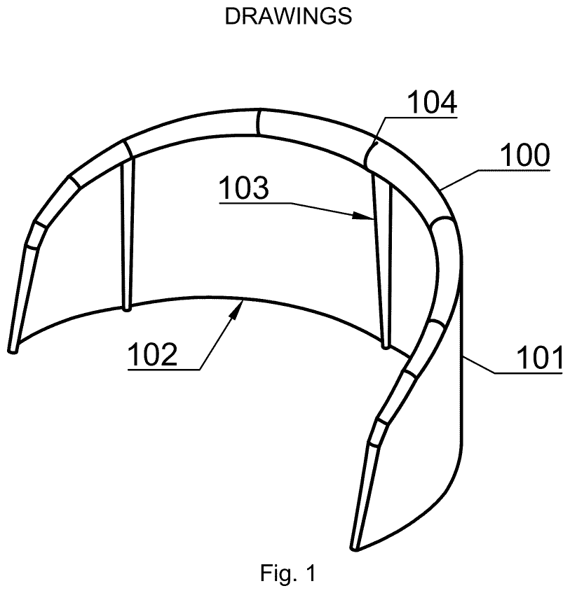

FIG. 1 illustrates a leading edge inflatable power kite used in certain embodiments. Such a power kite comprises a leading edge [100], a canopy [101], a trailing edge [102], and optionally further comprises inflated struts [103]. For such a power kite, the means of attachment may include attachment to one or multiple of these parts.

The location of the device should be chosen to provide relatively unimpeded air flow to minimize the impact on kite handling. The airflow is altered anywhere near the kite, but different locations alter the airflow different amounts. The underside of the canopy near the leading edge, or along a strut near the leading edge, is effectively sheltered from the airflow by the leading edge. An embodiment comprising an attachment to the trailing edge would likely impact the kite handling significantly. As such, the center of the leading edge [104] is believed to be the ideal location.

This location keeps the weight of the sensor close to the center of mass of the kite, minimizing an increase to the moment of inertia of the kite and thus minimizing the effect of slowing down turning speed. This location also maintains left-right symmetry.

The device should be attached in such a way that the angle of attack has a small impact on the measurement of apparent wind, or a means of determining angle of attack should be employed to calibrate out such error.

The ideal anemometry sensor to be used is believed to be an ultrasonic anemometer. Utilizing ultrasonic transducers [105], the wind speed is determined by measuring the difference in time of flight of sound waves transmitted between said transducers placed along the airflow path [107]. The lack of moving parts and fast response time of this type of anemometer make it well suited to the dynamic environment of being mounted on a kite. One such embodiment is shown in FIG. 7.

In this embodiment, the tendency of the kite to orient itself into the wind is used to allow measurement in only one dimension. The kite naturally orients the airflow path [107] along the direction of the wind, and the pair of ultrasonic transducers [105] bounce sound waves off a bounce place [106] to be received by the alternate transducer.

Other embodiments use alternative anemometry sensors. These other anemometer options include but are not limited to: Vane anemometers as described by U.S. Pat. No. 34,321A and hot-wire anemometers as described by U.S. Pat. No. 3,464,269A.

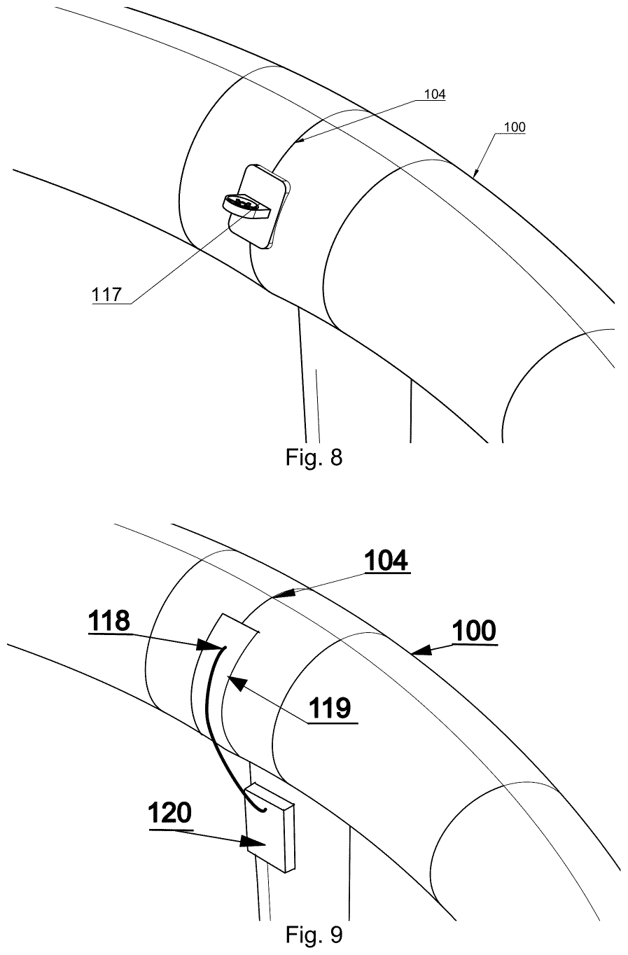

Vane anemometers are not seen as the best mode because the moving parts would wear quickly and clog with sand in the conditions kites are often flown. These also tend to have a slower response time. However, the simplicity of the electronics for such a device provides a manufacturing advantage. FIG. 8 illustrates an embodiment of the device utilizing such a vane anemometer [117].

Hot-wire anemometers are also not seen as the best mode because varying temperature and humidity lead to inaccuracies, especially in harsh or extreme conditions such as rain or when the kite crashes into water. Hot-wire anemometers also tend to be fragile. These limitations may be averted by via material choice and additional sensors to calibrate out those inaccuracies. One embodiment is illustrated in FIG. 9 where the wire [118] is traced along the leading edge [100] with an insulating patch [119] protecting the leading edge from thermal damage from the heated portion of the wire. This embodiment also includes a thermometer and hygrometer in an electronics housing [120] to aid in accounting for temperature and humidity variation. A similar embodiment may utilize a conductive film patch as a replacement for the hot wire section.

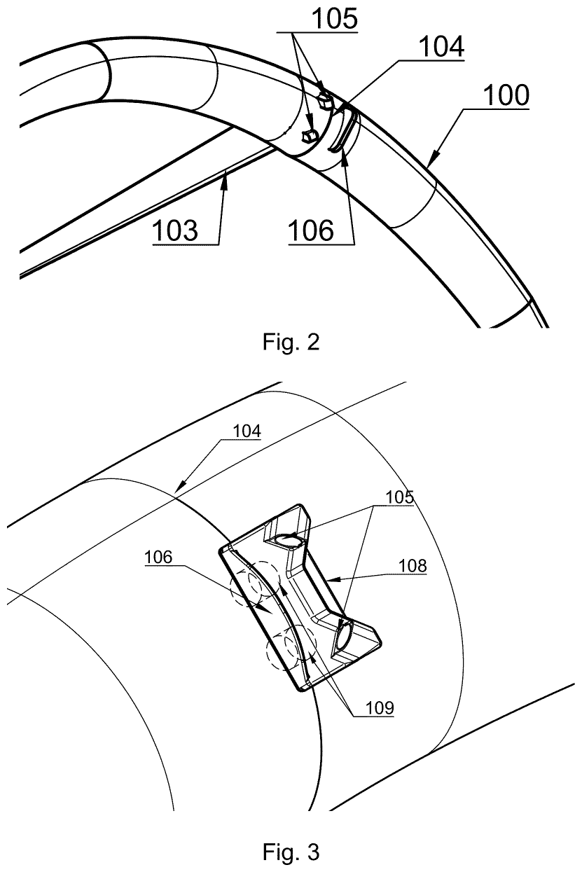

FIG. 2 illustrates an embodiment utilizing an ultrasonic anemometer wherein said device is integrated into the leading edge of a leading edge inflatable power kite. This example embodiment utilizes the structure of the leading edge [100] while inflated to hold the transducers [105] and bounce plate [106] in the right position when the leading edge is inflated.

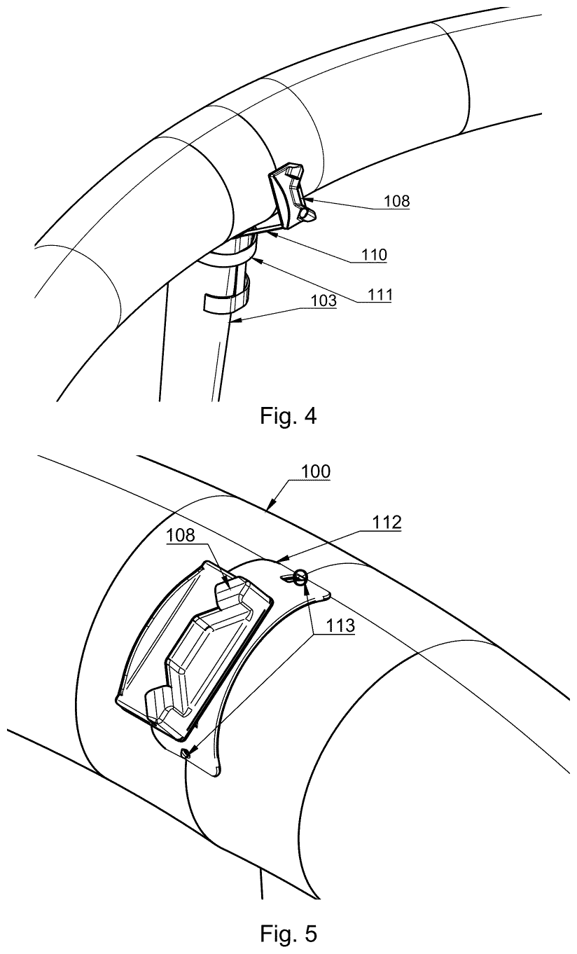

FIG. 3 illustrates an embodiment of the device [108] utilizing an ultrasonic anemometer wherein the means of attachment comprises strong magnets [109] adhered inside the leading edge near the center [104] and in the housing of the device. FIG. 4 illustrates an embodiment of the device [108] utilizing an ultrasonic anemometer wherein the means of attachment is via a mount [110] strapped [111] to the center strut [103]. FIG. 5 illustrates an embodiment of the device [108] utilizing an ultrasonic anemometer wherein the means of attachment is via a mount [112] attached to anchors [113] on the center of the leading edge. Certain leading edge inflatable power kites possess such anchors sewn into the leading edge to hold the kite in place while being inflated and/or to tether the cap for the inflate valve.

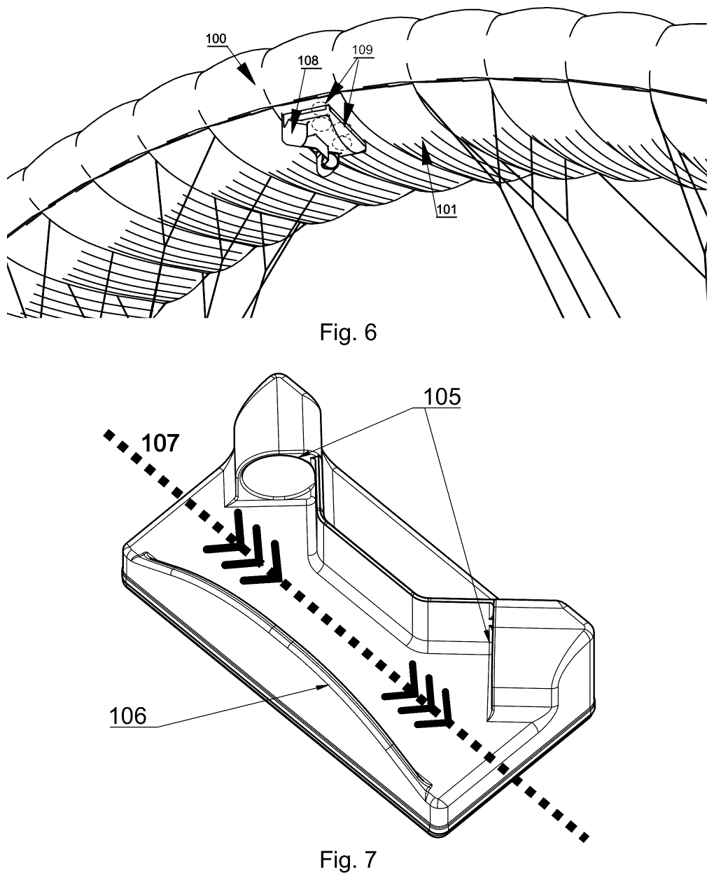

FIG. 6 illustrates an embodiment of the device attached to a ram-air power kite rather than a leading edge inflatable power kite. In this embodiment, the device [108] is attached to the canopy [101] of said kite. This is accomplished via strong magnets [109] on either side of the underside canopy.

The ideal embodiment of the device would be equipped with a means to relay wind data to a networked server. One embodiment includes a wireless antenna which transmits data to an external computing unit that is connected to the internet. For example: the device may pair to a smart phone or smart watch. An app on said computing unit can further process the data and relay it to a server. The server can then be connected to a website to show the latest wind measurements. Wind measurements collected from multiple devices can be aggregated and analyzed for trends, enabling a comprehensive understanding of wind conditions in various locations and scenarios.

Certain embodiments would also comprise additional environmental sensors whose data is shared in a similar way. Two such examples are temperature or pressure data, obtained by the inclusion of a thermometer or barometer, respectively.

The ideal embodiment of the device would also be equipped with an inertial measurement unit. The inclusion of an inertial measurement unit allows the kite motion to be characterized.

In one embodiment, the inertial measurement unit would be used to determine the rough magnitude of error the kite motion is likely causing the wind measurement, and only report the wind readings when the error is low. The error magnitude is related to how quickly the kite is moving and how well-oriented the kite is into the wind. If the angular velocity of the device is low, the kite is not turning quickly, and is likely stable on a roughly perpendicular arc to the wind direction. If the acceleration data is high the kite may be reacting to strong gusts, or the kite is moving forward before reaching that roughly perpendicular arc to the wind. Thus, a threshold value for the gyroscope and accelerometer data can throw out most of the erroneous data, at the cost of missing data for those moments of aggressive kite motion. In embodiments where the wind measurements are dependent on the angle of attack of the power kite, the data from the inertial measurement unit can be used to calibrate out such error.

In another embodiment, the entire motion of the kite is characterized and a model of how such motion affects wind readings is used to calibrate away such motion. By means of a sensor fusion algorithm, the orientation of the kite can be determined. Because the kite is tethered to the kiter, this orientation data gives most of the needed information to determine where the kite is relative to the kiter. There is an extra degree of freedom, however; as the angle of attack can change where the kite tilts about the tow point of the kite bridge, rather than about the kiter. This requires a motion model that accounts for the inertia of the kite and detects stable configurations where the state can be recalibrated. One embodiment would further include a barometer to provide altitude data point to further refine the motion model of the kite.

The ideal embodiment of the device would further comprise a means of obtaining GPS data. One such embodiment would include a GPS unit on the device itself, and another would utilize the GPS data from a wirelessly connected external computing unit (e.g. a smart phone or smart watch. The GPS data gives the horizontal velocity, and with an estimate of the true wind direction, the induced wind from kiter motion can be subtracted away from the apparent wind on the kite with simple vector algebra. This gives an estimate of the true wind.

In one embodiment the estimate for true wind direction is made using the GPS data and assumptions about the course a kiter is likely to take. During most sessions, recreational kite fliers tend to have roughly equal tack angles when moving to the left or right, the estimate for the upwind direction would be the average of those angles.

Another embodiment further comprises a magnetometer to estimate true wind direction. Said magnetometer provides the orientation of the kite relative to the cardinal directions. As the kite naturally orients itself into the wind, such orientation data can be used to determine the true wind direction.

The best mode embodiment is envisioned to comprise a 1-dimensional ultrasonic anemometry sensor, an inertial measurement unit, a magnetometer, a barometer, a thermometer, and a wireless antenna. The device is turned on just prior to mounting on the leading edge of a leading-edge inflatable kite with a mount utilizing anchors sewn into the leading edge of said kite. The device is wirelessly paired to a smart watch the kiter wears during their session. While the kiter is flying the kite, the data from the inertial measurement unit is combined with the magnetometer and barometer data to create a record of where and how the kite is flown. This data is streamed to the paired smart watch where it is combined with onboard GPS data and used to calculate the true wind. This true wind data, along with data from the onboard thermometer from the device, is then uploaded in real-time to a server and a website displays the current wind readings. After the session ends, the smart watch sends the data to a paired smart phone and the kiter receives a visualization of their session along with the historical kite motion, to aid them in training new skills.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

The invention claimed is:

1. A device comprising:
at least one anemometry sensor;
at least one electronic processing unit connected to said at least one anemometry sensor configured to process the data from said anemometry sensor;
and a means of attachment to a power kite.

2. The device of claim 1 wherein said power kite is a leading edge inflatable power kite.

3. The device of claim 2 wherein said means of attachment to a power kite is a mount holding said device to the leading edge.

4. The device of claim 2 wherein said means of attachment to a power kite is incorporation into the leading edge.

5. The device of claim 2 wherein said means of attachment to a power kite comprises an attachment to one or more struts of said leading edge inflatable power kite.

6. The device of claim 1 wherein said means of attachment to a power kite comprises an attachment to the canopy of said power kite.

7. The device of claim 1 wherein said means of attachment to a power kite comprises an attachment to the trailing edge of said power kite.

8. The device of claim 1 wherein at least one of said anemometry sensors is an ultrasonic anemometer.

9. The device of claim 8 wherein said ultrasonic anemometer is 1-dimensional, i.e. utilizes a single pair of ultrasonic transducers.

10. The device of claim 1 wherein at least one of said anemometry sensors is a vane anemometer.

11. The device of claim 1 wherein at least one of said anemometry sensors is a hot-wire anemometer.

12. The device of claim 1 further comprising an inertial measurement unit.

13. The device of claim 12 wherein data from said inertial measurement unit is used to account for measurement error stemming from kite motion.

14. The device of claim 1 further comprising a wireless antenna.

15. The device of claim 14 further comprising a means of relaying the wind data to a networked server.

16. The device of claim 1 further comprising a GPS unit.

17. The device of claim 16 wherein data from said GPS unit is used to correct for induced wind from kiter motion.

18. The device of claim 1 further comprising a magnetometer configured to provide wind direction data.

19. The device of claim 1 further comprising a thermometer.

20. The device of claim 1 further comprising a barometer.
